(19) United States
(12) Patent Application Publication
(10) Pub. No.: US 2026/0299273 A1
(43) Pub. Date: Oct. 1, 2026

(54) OPTICAL DEVICE FOR MODIFYING A LIGHT BEAM

(71) Applicant: Carl Zeiss Microscopy GmbH, Jena (DE)

(72) Inventors: Ralf Netz, Jena (DE); Joerg Siebenmorgen, Jena (DE); Richard Hollinger, Jena (DE)

(73) Assignee: Carl Zeiss Microscopy GmbH, Jena (DE)

(21) Appl. No.: 19/631,054

(22) Filed: Mar. 27, 2026

(30) Foreign Application Priority Data
Mar. 31, 2025 (DE) 10 2025 112 560.0

(51) Int. Cl. G02B 21/00; G02B 15/14; G02B 21/06; G02B 27/09

(52) U.S. Cl. CPC G02B 21/006; G02B 15/143; G02B 21/06; G02B 27/0961; G02B 27/0988

(57) ABSTRACT

An optical device for modifying a light beam has a first stop for delimiting the light beam in a first plane, a second stop for delimiting the light beam in a second plane aligned at a predefined non-zero angle, in particular perpendicularly, to the first plane, and a zoom unit for modifying the extent of the light beam, the zoom unit having comprising at least one fixed lens and at least two, in particular at least three, lenses that are movable relative to the fixed lens along a first axis.

### CROSS-REFERENCE TO RELATED APPLICATIONS

This patent application claims priority to German Patent Application No. 10 2025 112 560.0, filed on 31 Mar. 2025, in the German Patent and Trademark Office, the entire disclosure of which is hereby incorporated by reference herein.

### BACKGROUND OF THE INVENTION

### Field of the Invention

The invention relates to an optical device for modifying a light beam and to a method for generating a modified light beam.

### Description of Related Art

In the field of light-sheet microscopy and line scanners, zoom units, one of which is described in EP 3 879 329 A1, are often used to dimension the light sheet or the scan line or to modify a light beam.

FIG. 4 shows a schematic view of the xy-plane of a first optical device 10′ according to the prior art. The first optical device 10′ is designed to modify the shape or extent of the light beam 15′. FIG. 5 shows a schematic view of the xz-plane of the optical device from FIG. 4. The optical device 10′ according to the prior art comprises a zoom unit 40′. The optical device 10′ comprises a cylindrical lens 35′ upstream of the zoom unit 40′. The zoom unit 40′ comprises three jointly movable lenses 45′, 46′, 47′, which are movable relative to a fixed lens 42′. Subsequently, the light beam 15′ reaches a scanning lens 50′ and then a first tube lens 52′. Subsequently, the object 65′ is partially illuminated with the modified light beam 15′ via the illumination objective 60′. The light from the object 65′ passes through a detection objective 67′, an emission filter 69′ and a second tube lens 70′ to an image sensor 75′ (e.g. sCMOS). A plane 1 (pupil plane) 80′ is arranged between the cylindrical lens 35′ and the zoom unit 40′. A plane 2 (pupil plane) 82′ is arranged between the zoom unit 40′ and the scanning lens 50′. A plane 3 (intermediate image plane) 84′ is arranged between the scanning lens 50′ and the first tube lens 52′. A plane 4 (pupil plane) 86′ is arranged between the first tube lens 52′ and the illumination objective 60′.

The zoom factor or magnification factor of the optical device 10′ or zoom unit 40′ can be changed by moving the movable lenses 45′, 46′, 47′ relative to the fixed lens 42′. This means that the extent of the light beam 15′ in the y-direction and in the z-direction can be modified. A disadvantage here is that the light beam 15′ can be modified only to a limited extent. This means that the zoom factor can only be changed to a limited extent.

FIG. 6 shows a schematic view of the xy-plane of a second optical device 10′ according to the prior art. FIG. 7 shows a schematic view of the xz-plane of the optical device 10′ from FIG. 6. The second optical device 10′ is designed to modify the shape or extent of the light beam 15′. In addition to a pivot scanner 20′ or mirror, the second optical device 10′ comprises a first stop 30′ and a second stop 33′. A cylindrical lens 35′ is arranged between the first stop 30′ and the second stop 33′. A scanning lens 50′ is arranged downstream of the second stop 33′ (in the beam direction of the light beam 15′), and this is followed by a first tube lens 52′. Then, the modified light beam 15′ passes through an illumination objective 60′ onto an object 65′. The light from the object 65′ passes through a detection objective 67′ and an emission filter 69′ as well as a second tube lens 70′ to an image sensor 75′ (e.g. sCMOS).

It is possible to change the zoom factor or magnification factor of the optical device 10′ by modifying the opening or the size of the openings of the first stop 30′ and of the second stop 33′. Increasing the opening of the first stop 30′ increases the numerical aperture upstream of the scanning lens 50′. This increases the width of the light beam 15′ (dimension of the light beam 15′ in the y-direction) in the intermediate image, and the laser transmission through the optical device 10′ increases or grows.

Closing the second stop 33′ decreases the numerical aperture upstream of the scanning lens 50′. This increases the light sheet thickness (in the z-direction) in the intermediate image, and the laser transmission decreases.

The fact that the extent of the light beam 15′ in the y-direction and in the z-direction can be modified only to a limited extent is a disadvantage of the second optical device 10′ as well.

### SUMMARY OF THE INVENTION

The problem addressed by the invention is that of specifying an optical device and a method which allow modification of the extent of the light beam over a wide range in a technically simple manner.

This invention includes but is not limited to the following embodiments:
1 An optical device for modifying a light beam, the optical device comprising:
a first stop for delimiting the light beam in a first plane,
a second stop for delimiting the light beam in a second plane aligned at a predefined non-zero angle to the first plane,
and
a zoom unit for modifying the extent of the light beam, the zoom unit comprising at least one fixed lens and at least two lenses that are movable relative to the fixed lens along a first axis.
2. The optical device as described in embodiment 1, wherein
the first stop and/or the second stop are arranged upstream of the zoom unit in the direction of the light beam.

3. The optical device as described in embodiment 1, wherein
the zoom unit is designed such that the light beam is optionally modified in the first plane and in the second plane.

4. The optical device as described in embodiment 1, wherein
the optical device is designed such that the extent of the light beam is decreased by the optical device.

5. The optical device as described in embodiment 1, wherein
the distances between the movable lenses and the fixed lens are optionally adjusted over a continuous range.
6. The optical device as described in embodiment 1, wherein
a lens is arranged between the first stop and the second stop.
7. The optical device as described in embodiment 1, wherein
the zoom unit is designed such that the extent of the light beam is modified in two planes that are oriented perpendicularly to each other.
8. The optical device as described in embodiment 1, wherein
the first stop and the second stop are arranged such that an increase in a diameter of the first stop and a decrease in a diameter of the second stop both lead to an increased extent of the light beam.
9. A beam device, comprising:
an optical device as described in embodiment 1, and
a light device for generating the light beam.
10. A light-sheet microscope, comprising:
an optical device as described in embodiment 1.
11. A confocal microscope, comprising:
an optical device as described in embodiment 1.
12. A method for generating a modified light beam, the method comprising:
generating a light beam;
guiding the light beam through a first stop for delimiting the light beam in a first plane;
guiding the light beam through a second stop for delimiting the light beam in a second plane aligned at a predefined non-zero angle to the first plane; and
guiding the light beam through a zoom unit for modifying the extent of the light beam, the zoom unit comprising at least one fixed lens and at least two lenses that are movable relative to the fixed lens along a first axis.
13. The method as described in embodiment 12, further comprising:
adjusting the distance between the movable lenses and the fixed lens over a continuous range in order to modify the light beam.
14. The method as described in embodiment 13, wherein
the light beam is initially guided through the first stop and/or the second stop, before the light beam is guided into the zoom unit.
15. The method as described in embodiment 12, wherein
the extent of the light beam is increased by the zoom unit.

### BRIEF DESCRIPTION OF THE DRAWINGS

FIG. 1 shows a schematic view of the xy-plane of an exemplary embodiment of the optical device according to the invention.

FIG. 2 shows a schematic view of the xz-plane of the optical device from FIG. 1.

FIG. 3 shows a schematic view of the various sizes of the light beam that are adjustable by means of the optical device according to FIG. 1 or according to FIG. 2.

FIG. 4 shows a schematic view of the xy-plane of a first optical device according to the prior art.

FIG. 5 shows a schematic view of the xz-plane of the optical device from FIG. 4.

FIG. 6 shows a schematic view of the xy-plane of a second optical device according to the prior art.

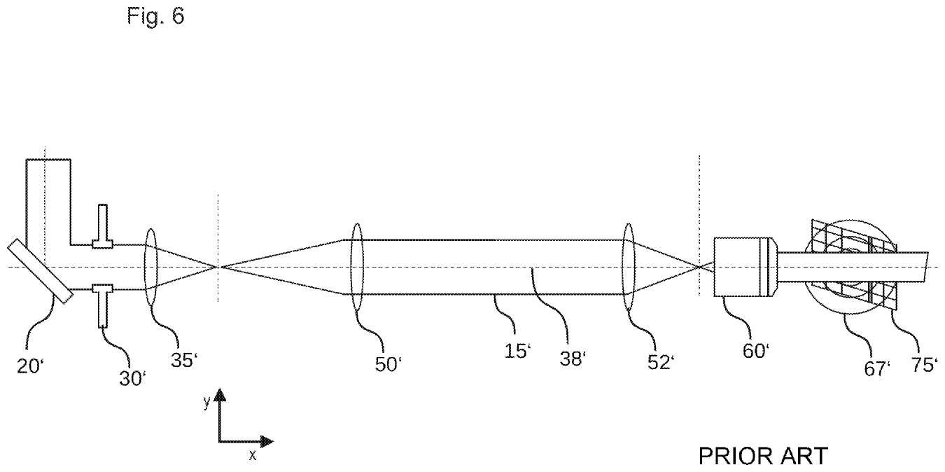

FIG. 7 shows a schematic view of the xz-plane of the optical device from FIG. 6.

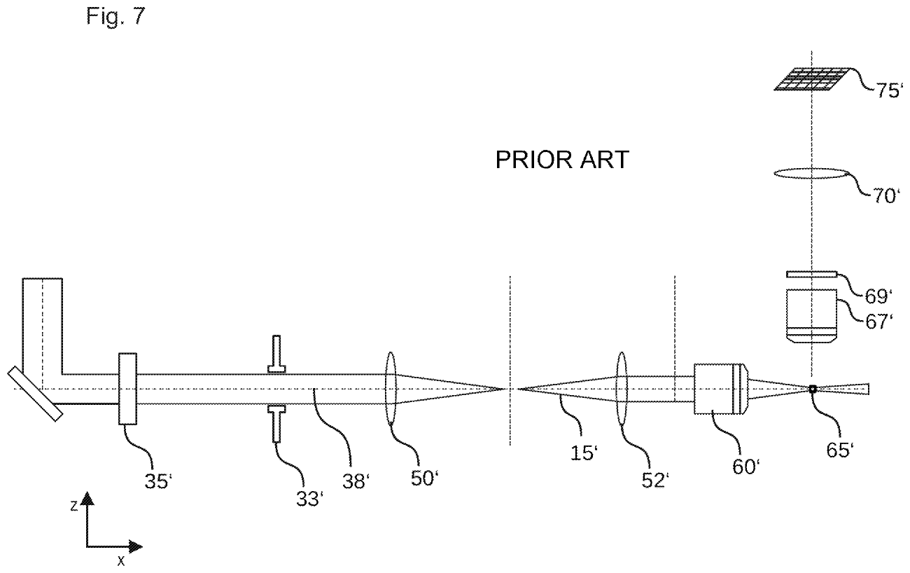

### DETAILED DESCRIPTION OF THE INVENTION

This problem is solved by an optical device as described in embodiment 1.

In particular, the problem is solved by an optical device for modifying a light beam, the optical device comprising the following: a first stop for delimiting the light beam in a first plane, a second stop for delimiting the light beam in a second plane aligned at a predefined non-zero angle, in particular perpendicularly, to the first plane, and a zoom unit for modifying the extent of the light beam, the zoom unit comprising at least one fixed lens and at least two, in particular at least three, lenses that are movable relative to the fixed lens along a first axis.

An advantage thereof is that the combination of the stops and the zoom unit allows the light beam to be modified over a wide range. In particular, the shape of the light beam or its size or extent in the first plane and in the second plane can be modified over a large range. In particular, this can mean that the width or extent of the light beam in the first plane can be modified or increased or decreased over a large range and that the width or extent of the light beam in the second plane can be modified or increased or decreased over a large range.

The problem is also solved by a method as described in embodiment 12.

In particular, the problem is solved by a method for generating a modified light beam, in particular using an optical device as described above, the method comprising the following steps: generating a light beam; guiding the light beam through a first stop for delimiting the light beam in a first plane; guiding the light beam through a second stop for delimiting the light beam in a second plane aligned at a predefined non-zero angle, in particular perpendicularly, to the first plane; and guiding the light beam through a zoom unit for modifying the extent of the light beam, the zoom unit comprising at least one fixed lens and at least two, in particular at least three, lenses that are movable, preferably jointly movable, relative to the fixed lens along a first axis.

An advantage of this method is that the shape of the light beam can be modified over a large range by means of the combination of two stops and a zoom unit. The extent or dimension of the light beam in the first plane and in the second plane can be modified in a technically simple manner.

The problem is also solved by a beam device comprising an optical device as described above and a light device for generating the light beam.

The problem is also solved by a light-sheet microscope comprising an optical device as described above or comprising a beam device as described above.

The problem is also solved by a confocal microscope, in particular a laser scanning microscope, comprising an optical device as described above or comprising a beam device as described above.

According to an embodiment of the optical device, the first stop and/or the second stop are arranged upstream of the zoom unit in the direction of the light beam. As a result, the light beam can be modified particularly effectively and in a technically simple manner by means of the zoom unit.

According to an embodiment of the optical device, the zoom unit is designed such that the light beam can be modified in the first plane and in the second plane. An advantage thereof is that the light beam can be modified in both dimensions in a technically simple and precise manner.

According to an embodiment of the optical device, the optical device is designed such that the extent of the light beam is decreased by means of the optical device. An advantage thereof is that this allows a particularly thin light beam or a light beam with a small extent to be generated. As a result, objects can be examined in particular detail using the modified light beam.

According to an embodiment of the optical device, the distances between the movable lenses and the fixed lens can be adjusted over a continuous range. An advantage thereof is that the shape of the light beam, e.g. the thickness or the breadth and width, can be modified over a continuous range.

According to an embodiment of the optical device, a lens, in particular a cylindrical lens, is arranged between the first stop and the second stop. An advantage thereof is that the light beam can be modified particularly easily from a technical point of view.

According to an embodiment of the optical device, the zoom unit is designed such that the extent of the light beam is modified in two planes that are oriented perpendicularly to each other. An advantage thereof is that the shape of the light beam can be modified in both dimensions in a technically simple manner.

According to an embodiment of the optical device, the first stop and the second stop are arranged such that an increase in a diameter of the first stop and a decrease in a diameter of the second stop both lead to an increased extent of the light beam. An advantage thereof is that the light transmission or the amount of light passing through the optical device thus remains substantially unchanged even though the shape of the light beam is modified.

According to an embodiment of the method, the method further comprises the following step: adjusting the distance between the movable lenses and the fixed lens over a continuous range in order to modify the light beam. An advantage thereof is that the shape of the light beam can be modified substantially over a continuous range.

According to an embodiment of the method, the light beam is initially guided through the first stop and/or the second stop, before the light beam is guided into the zoom unit. An advantage of this method is that the shape of the light beam can be modified particularly easily from a technical point of view.

According to an embodiment of the method, the extent of the light beam is increased by the zoom unit. An advantage thereof is that a particularly thin light beam or a light beam with a small thickness and width is generated.

The concept underlying the invention is that of combining the use of two stops and a zoom unit, which comprises a fixed lens and a plurality of lenses movable relative to the fixed lens, to modify a light beam in order thus to modify or be capable of modifying the shape of the light beam over a wide range.

Preferred embodiments will emerge from the dependent embodiments. The invention is explained in greater detail below with reference to drawings of exemplary embodiments.

The same reference signs are used in the following description for parts that are the same and parts that act in the same way.

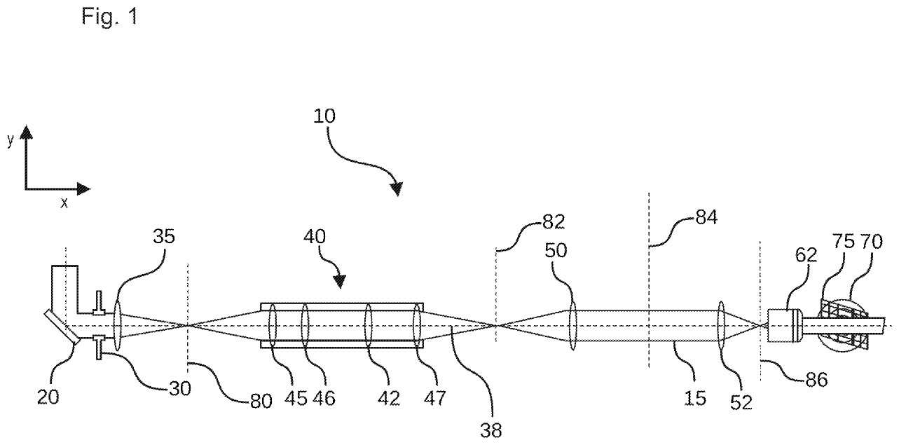

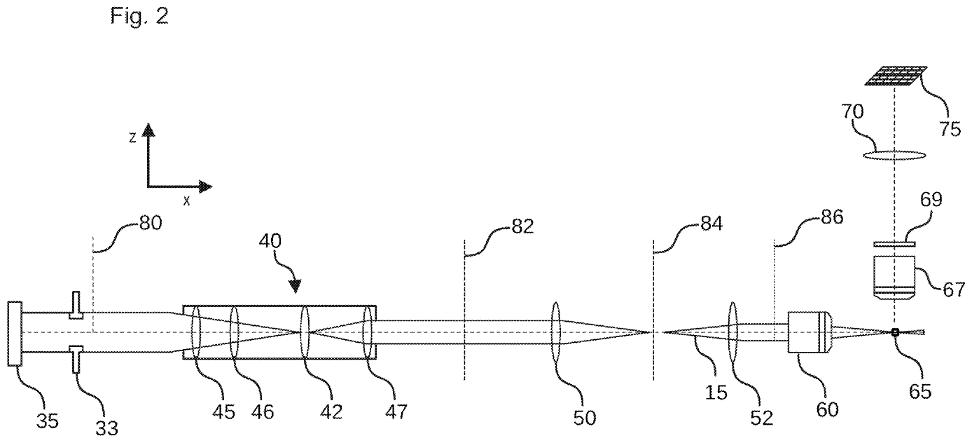

FIG. 1 shows a schematic view of the xy-plane of an exemplary embodiment of the optical device 10 according to the invention. FIG. 2 shows a schematic view of the xz-plane of the optical device 10 from FIG. 1.

For most or the majority of FIG. 1 and throughout FIG. 2, the direction of the light beam 15 or the beam direction runs from left to right, i.e. in the x-direction. The first axis 38 extends parallel to the x-direction in the center of the optical device. The first plane can be the xy-plane. The second plane can be the xz-plane. In FIG. 1, the x-direction runs from left to right, and the y-direction runs from bottom to top. In FIG. 2, the x-direction runs from left to right, and the z-direction runs from bottom to top.

The optical device 10 is designed to modify a light beam 15 entering the optical device 10. In particular, the shape of the light beam 15 is modified by the optical device 10. The shape of the light beam 15 in particular comprises the extent of the light beam 15 in the y-direction and in the z-direction.

The optical device 10 comprises a first stop 30 and a second stop 33. The first stop 30 and the second stop 33 both delimit the light beam 15. In particular, this may mean that a portion of the light beam 15 does not pass through the respective stop 30, 33.

The light beam 15 is generated by a light source (not shown), e.g. by a laser. In FIG. 1, the light beam 15 firstly reaches a pivot scanner 20 from above. The pivot scanner 20 is a rotatable mirror. It can be used to modify the position of the light beam 15 on an object 65. Subsequently, the light beam 15 passes through a first stop 30 of the optical device 10. The first stop 30 or the opening of the first stop 30 can be modified in the xy-plane, i.e. its size can be increased or decreased. As a result, it is possible to modify the shape of the light beam 15 or the extent of the light beam 15 in the xy-plane, level with the first stop 30. In particular, the extent of the light beam 15 in the y-direction can be modified by the first stop 30.

A cylindrical lens 35 of the optical device 10 is arranged downstream of the first stop 30. The cylindrical lens 35 focuses the light beam 15 such that in plane 1 (pupil plane) 80, the said light beam has a small extent in the xy-plane. In the xy-plane, the cylindrical lens 35 has a biconvex shape. In the xz-plane, the cylindrical lens 35 has a rectangular shape or a rectangular cross section.

The second stop 33 is arranged between the cylindrical lens 35 and the plane 1 (in the beam direction or x-direction) 80. The second stop 33 delimits the light beam 15 in the xz-plane. That is to say, the second stop 33 delimits the size of the light beam 15 in the xz-plane. In particular, the extent of the light beam 15 in the z-direction can be modified by the second stop 33. The opening or the diameter of the second stop 33 in the xz-plane can be modified, i.e. increased or reduced in size. In the x-direction, the second stop 33 is not level with or situated at the same position as the first stop 30; instead, the second stop 33 is disposed downstream of the first stop 30 in the beam direction or the x-direction.

The first stop 30 acts in the intermediate image plane. The second stop 33 acts in the pupil plane.

Level with the plane 1, the light beam 15 has a small extent in the xy-plane or a small diameter in the xy-plane. Level with the plane 1, the light beam 15 has a large extent or a large diameter in the xz-plane, wherein the extent can be set by the second stop 33.

A zoom unit 40 is arranged downstream of the plane 1 in the beam direction. The zoom unit may be an afocal zoom unit. The zoom unit 40 comprises at least one fixed lens 42 and at least two, in particular at least three, movable lenses 45, 46, 47. The two or three movable lenses 45, 46, 47 move or can be moved along the axis of the beam direction relative to the fixed lens 42 (which, level with the zoom unit 40, runs from left to right or in the x-direction and counter to the x-direction in FIG. 1 and FIG. 2). This means that the distance between the movable lenses 45, 46, 47 and the at least one fixed lens 42 can be modified. In particular, the two or three movable lenses 45, 46, 47 can be displaced jointly. In particular, this may mean that the distances between the two or three movable lenses 45, 46, 47 relative to one another remain unmodifiable during their movement. By preference, the distance between the movable lenses 45, 46, 47 and the at least one fixed lens 42 can be adjusted or modified over a continuous range.

The zoom factor or magnification factor can be set by means of the zoom unit 40. In particular, this may mean the amount by which the extent of the light beam 15 in the y-direction and in the z-direction is modified by means of the zoom unit 40. For example, the zoom factor can be set in a range from approx. 0.4 to approx. 1.68 by means of the zoom unit 40. In particular, this may mean that the size or the extent of the light beam 15 entering the zoom unit 40 is modified accordingly.

The extent of the light beam 15 in the xy-plane is large within the zoom unit 40. The extent in the y-direction in particular is large. In the zoom unit 40, the extent of the light beam 15 in the xz-plane initially decreases and increases again after a minimum has been reached. In the zoom unit 40, the extent in the z-direction in particular initially decreases and then increases again.

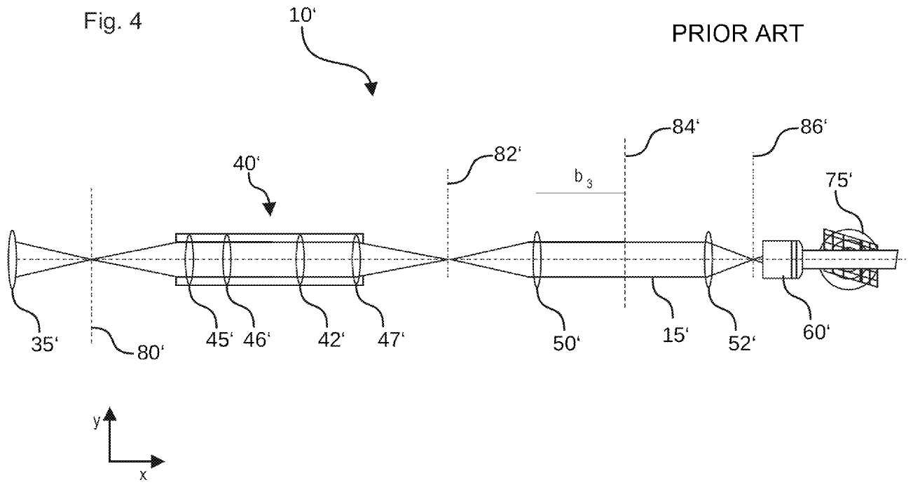

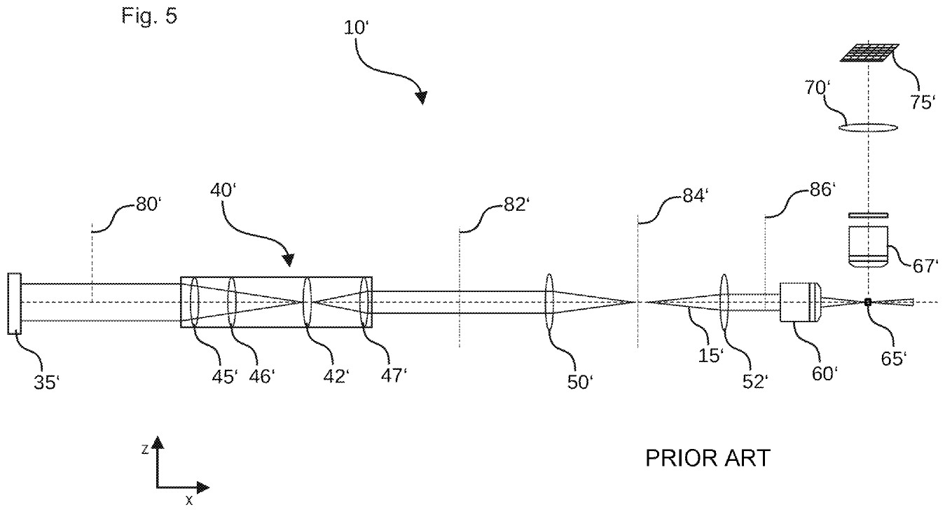

In particular, the zoom unit 40 can be a device as described in EP 3 879 329 A1. Such a device was described above, within the description of the prior art, and is shown in FIG. 4 and FIG. 5.

The plane 2 (pupil plane) 82 is arranged between the zoom unit 40 and a scanning lens 50 or a first tube lens 52. Hence, the plane 2 is disposed downstream of the zoom unit 40 in the x-direction or in the beam direction. Level with the plane 2, the extent of the light beam 15 in the xy-plane is minimal or small. The extent in the y-direction in particular is small. Level with the plane 2, the extent of the light beam 15 in the xz-plane is large or maximal. The extent in the z-direction in particular is large.

A scanning lens 50 is arranged downstream of the plane 2 in the beam direction or x-direction. The scanning lens 50 is at a distance fscan, which corresponds to the focal length of the scanning lens 50, from the plane 2. A plane 3 (intermediate image plane) 84 is arranged downstream of the scanning lens 50 in the beam direction. The distance between the plane 3 and the scanning lens 50 is equal to the focal length fscan of the scanning lens 50. Level with the plane 3, the extent of the light beam 15 in the xy-plane or in the y-direction is large or maximal, while the extent in the xz-plane or in the z-direction is small or minimal. The scanning the lens 50 has a circular symmetry both in the xy-plane and in the xz-plane.

The light sheet itself is visible or present for the first time around the focal plane of the scanning lens 50.

A first tube lens 52 is arranged downstream of the plane 3 in the beam direction or x-direction. A plane 4 (pupil plane) 86 is arranged downstream of the first tube lens 52 in the beam direction or x-direction. Level with the plane 4, the extent of the beam is minimal in the xy-plane or in the y-direction and maximal in the xz-plane or in the z-direction.

Downstream of the plane 4, the light beam 15 enters an illumination objective 60 and is directed at the object 65 or a part of the object 65 as a result. A detection objective 67 is arranged and aligned perpendicular to the beam direction or x-direction or in the xz-plane. The detection objective 67 receives light from the object 65, said light reaching the object 65 from the illumination objective 60 by means of the light beam 15 and optionally being converted by the object 65.

The light exits the detection objective 67 and passes through an optional emission filter 69. Subsequently, the light passes through a further or second tube lens 70 to a light detector or an image sensor 75, e.g. an sCMOS chip.

By combining the zoom unit 40 with the first stop 30 and the second stop 33, it is possible to extend the zoom factor, specifically to larger zoom factors or to smaller zoom factors. The maximum value and minimum value of the zoom factor can be modified by the first stop 30 and the second stop 33. For example, a zoom factor of the zoom unit 40 can range between 0.5 and 5.0 (without the effect of the stops). Using the first stop 30 and the second stop 33, this range may for example be modified to the range of 2.0 to 20.0. In particular, this may mean that the shape of the light beam 15 becomes thinner and narrower, i.e. has a smaller extent in the y-direction and in the z-direction. It is also conceivable that the shape of the light beam 15 becomes thicker and wider. Expressed differently, the optical device 10 allows the zoom factor or the light beam 15 to be modified over a large range or over a large value range or over a wide range.

It is advantageous for the beam parameters of the light beam 15 to be chosen such that the first stop 30 and the second stop 33 can develop their effect and the input beam does not exceed the limits of the zoom unit 40 (maximum opening or maximum opening angle).

The zoom unit 40 operates between the two pupil planes with a variable zoom factor or imaging scale βₒₚₜ. As a result, the light beam thickness Oz and light beam width Wy in the object plane or level with the object 65 can be varied, in accordance with the following formulas:

$${ω}_{z} = \frac{{ω}_{0 z}}{{β}_{opt}}$$

$${ω}_{y} = \frac{{ω}_{0 y}}{{β}_{opt}}$$

The light beam thickness ω_{0z} is the light beam thickness ω_{z} for an imaging scale βₒₚₜ=1. The light beam width ω_{0y} is the light beam width ω_{y} for an imaging scale βₒₚₜ=1.

The zoom unit 40 allows a minimum value for the light beam thickness of

$${ω}_{z , min} = \frac{{ω}_{0 z}}{{β}_{opt , max}}$$

The zoom unit 40 allows a minimum value for the light beam width of

$${ω}_{y , min} = \frac{{ω}_{0 y}}{{β}_{opt , max}} .$$

The zoom unit 40 allows a maximum value for the light beam thickness of

$${ω}_{z , max} = \frac{{ω}_{0 z}}{{β}_{opt , min}}$$

The zoom unit 40 allows a maximum value for the light beam width of

$${ω}_{y , max} = \frac{{ω}_{0 y}}{{β}_{opt , min}}$$

The first stop 30 and the second stop 33 allow a shift of the minimum values and maximum values of ω_{z} and ω_{y}.

The minimum values and maximum values in the y-direction and in the z-direction are modifiable independently of one another by the first stop 30 and the second stop 33.

Increasing the opening of the first stop 30—or opening the first stop 30 further-increases the numerical aperture upstream of the scanning lens 50. This increases the light beam width in the intermediate image. Consequently, the light transmission or laser transmission through the optical device 10 is increased.

Decreasing the opening of the second stop 33—or closing the second stop 33 further—decreases the numerical aperture upstream of the scanning lens 50. The light beam width in the intermediate image is increased as a result. Consequently, the light transmission or the laser transmission through the optical device 10 is decreased.

It is possible to define a stop factor βₛₜₒₚ, similar to the zoom factor or magnification factor βₒₚₜ, for the y-direction and for the z-direction:

$${β}_{stop , y} ∼ \frac{1}{{L}_{y}}$$

$${β}_{stop , z} ∼ {L}_{z} ,$$

where
L_{y} is the diameter of the first stop 30 (in the y-direction), and
L_{z} is the diameter of the second stop 33 (in the z-direction).

That is to say, the first stop 30 has a diameter of L_{y}, and the second stop 33 has a diameter of L_{z}.

Consequently, the following then applies:

$${ω}_{z} = \frac{{ω}_{0 z}}{{β}_{stop , z} \cdot {β}_{opt}} and {ω}_{y} = \frac{{ω}_{0 y}}{{β}_{stop , y} \cdot {β}_{opt}}$$

For a middle position L_{y,0} and L_{z,0} of the sizes or diameters of the first stop 30 or of the second stop 33 L_{y} and L_{z}, it is consequently possible to define the following:

$${β}_{stop , z} ( {L}_{s , 0} ) := 1$$

$$and$$

$${β}_{stop , y} ( {L}_{y , 0} ) := 1.$$

The middle position of the first stop 30 can be, in particular, the midpoint between the largest possible opening of the first stop 30 and the smallest possible opening of the first stop 30. The middle position of the second stop 33 can be, in particular, the midpoint between the largest possible opening of the second stop 33 and the smallest possible opening of the second stop 33.

The combination of, firstly, the first stop 30 and the second stop 33 and, secondly, the zoom unit 40 allows the new or modified minimum values for the extent of the modified light beam in the z-direction or in the y-direction downstream of the optical device 10:

$${ω}_{z , min} = \frac{{ω}_{0 z}}{{β}_{stop , z , max} \cdot {β}_{opt , max}}$$

$${ω}_{y , min} = \frac{{ω}_{0 y}}{{β}_{stop , y , max} \cdot {β}_{opt , max}}$$

The combination of, firstly, the first stop 30 and the second stop 33 and, secondly, the zoom unit 40 allows the new or modified maximum values for the extent of the modified light beam in the z-direction or in the y-direction downstream of the optical device 10:

$${ω}_{z , max} = \frac{{ω}_{0 z}}{{β}_{stop , z , min} \cdot {β}_{opt , min}}$$

$${ω}_{y , max} = \frac{{ω}_{0 y}}{{β}_{stop , y , min} \cdot {β}_{opt , min}}$$

As evident from FIG. 1 and FIG. 2, L_{y} and L_{z} work against one another (i.e. the diameter of an opening of one stop 30, 33 must be increased, while the diameter of an opening of the other stop 33, 30 is decreased, or vice versa) in order to achieve a decrease or increase in the extent of the modified light beam 15 or light sheet. In the process, the light transmission or amount of light passing through the optical device 10 substantially does not change.

If the input light beam or the light beam 15 entering the optical device 10 is restricted or modified by the same factor in both dimensions (y-direction and z-direction) in the middle position of the first stop 30 and in the middle position of the second stop 33, then there is no change—or only a slight change—in the light transmission or laser transmission when the extent of the light beam 15 or of the light sheet is reduced or increased. This means that the intensity of the light beam 15 or the light intensity is not modified or reduced or only modified or reduced slightly. Mathematically, this can be expressed as follows:

$${β}_{stop , y} \cdot {β}_{stop , z} ∼ \frac{{L}_{z}}{{L}_{y}} .$$

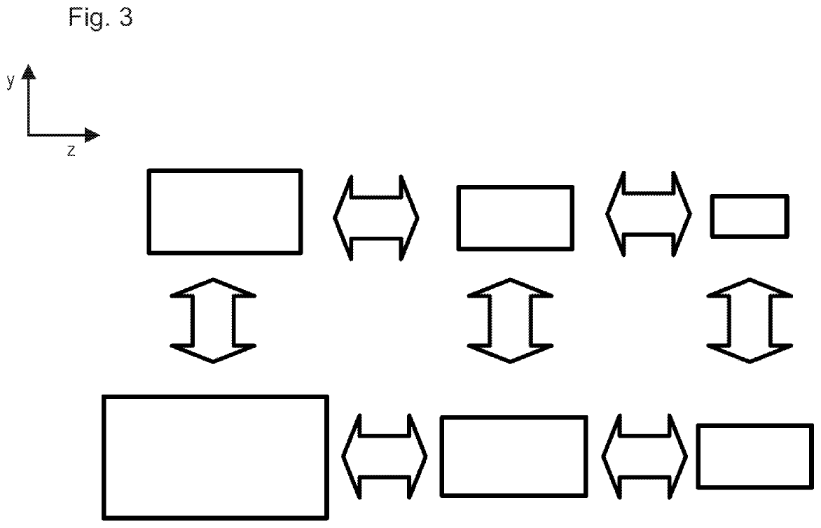

FIG. 3 shows a schematic view of the various sizes or extents of the light beam 15 that are adjustable by means of the optical device 10 according to FIG. 1 or according to FIG. 2. In FIG. 3, the y-direction runs from bottom to top, and the z-direction runs from left to right. The light distribution in the pupil plane is shown in each case.

The top line or row shows three sizes or extents of the light beam 15. The horizontal double-headed arrows, the tips of which point to the left and right, represent the possible modifications to the extent of the light beam 15 by the zoom unit 40. The vertical double-headed arrows, the tips of which point upward and downward, represent the possible modifications to the light beam 15 by the first stop 30 and the second stop 33 or by modifying the first stop 30 and the second stop 33.

The middle of the top line and the middle of the bottom line each show the extent of the light beam 15 in the yz-plane upstream of the zoom unit 40. When the zoom unit satisfies βₒₚₜ=1, the middle of the top line and the middle of the bottom line each show the extent of the light beam 15 in the yz-plane downstream of the zoom unit 40. Moreover, the top line shows the extents of the respective light beam 15 in the yz-plane for β_{stop,z,min}/β_{stop,y,min} downstream of the zoom unit 40. Moreover, the bottom line shows the extents of the respective light beam in the yz-plane for β_{stop,z,max}/β_{stop,y,max} downstream of the zoom unit 40. Top left and top right and bottom left and bottom right each show the extents of the light beam 15 downstream of the zoom unit 40 (for βₒₚₜ≠1). As it were, it is possible to switch between the top line and the bottom line in FIG. 3 by modifying the first stop 30 and the second stop 33.

The width (in z-direction) of the light beam 15 in the middle of the bottom line in FIG. 3 corresponds to the size of the second stop 33. The extent of the light beam 15 in the y-direction in the middle of the bottom line in FIG. 3 corresponds to the reciprocal of the size of the first stop 30.

It is conceivable that the optical device 10 does not reduce the extent of the light beam 15 (in the y-direction and in the z-direction) but instead that the optical device 10 increases the extent of the light beam 15 (in the y-direction and in the z-direction). The optical device 10 can be configured or arranged relative to the light source such that, as it were, the light beam passes through the elements of the optical device 10 in reverse. In that case, the zoom factor leads to an increase in the dimensions of the light beam 15.

In the formulas provided above, the assumption was made that the intensity of the light beam is constant as a function of the lateral position in the beam cross section and has a discontinuity from the maximum to zero at the edge of the light beam 15; this assumption was made to simplify matters. However, this is usually not exactly the case in reality. At the edge of the light beam 15, the intensity changes continuously from zero to the maximum value of the intensity in the middle of the light beam 15. As a result, the beam profile of the light beam then affects the speed at which there are changes in the light power or laser power in the two axes if the sizes of the first stop 30 and of the second stop 33 are modified along the two axes or in the two directions (y-direction and z-direction), for example whether the modifications along the two axes completely cancel each other out.

As a result of the beam profile or the intensity profile of the light beam 15, the following does not strictly apply to the change in intensity I of the light beam 15, for example:

$$Δ {I}_{Z} ∼ Δ {L}_{z}$$

Instead, the following nonlinear relationship applies to the intensity of the light beam 15:

$$Δ {I}_{Z} ∼ f ( Δ {L}_{Z} )$$

For example, this can be determined or calculated numerically.

It is also conceivable that the first stop 30 and the second stop 33 are not arranged upstream of the zoom unit 40, as shown in FIG. 1 and FIG. 2; instead, the first stop 30 and the second stop 33 could be arranged downstream of the zoom unit 40. It is also conceivable that the first stop is arranged upstream of the zoom unit 40 and the second stop 30 is arranged downstream of the zoom unit 40, or vice versa.

The diameter of the light beam 15 or light sheet can for example be set in the range from approx. 1 micrometer to approx. 10 micrometers or approx. 15 micrometers.

In particular, the modified light beam 15 can be used for light-sheet microscopy. The optical device 10 can be part of a light-sheet microscope.

It is also conceivable that the modified light beam 15 is used for confocal microscopy or for a confocal line scanner. The optical device 10 can be part of a confocal microscope.

The light beam 15 can be modified by beams of an SLM (e.g. grating structure and/or amplitude modulation).

### LIST OF REFERENCE SIGNS

10, 10′ Optical device
15, 15′ Light beam
20, 20′ Pivot scanner
30, 30′ First stop
33, 33′ Second stop
35, 35′ Cylindrical lens
38, 38′ First axis
40, 40′ Zoom unit
42, 42′ Fixed lens
45, 46, 47, 45′, 46′, 47′ Movable lenses
50, 50′ Scanning lens
52, 52′ First tube lens
60, 60′ Illumination objective
65, 65′ Object
67, 67′ Detection objective
69, 69′ Emission filter
70, 70′ Second tube lens
75, 75′ Image sensor (e.g. sCMOS)
80 Plane 1 (pupil)
82 Plane 2 (pupil)
84 Plane 3 (intermediate image)
86 Plane 4 (pupil)

1. An optical device for modifying a light beam, the optical device comprising:
a first stop for delimiting the light beam in a first plane,
a second stop for delimiting the light beam in a second plane aligned at a predefined non-zero angle to the first plane,
and
a zoom unit for modifying the extent of the light beam, the zoom unit comprising at least one fixed lens and at least two lenses that are movable relative to the fixed lens along a first axis.

2. The optical device as claimed in claim 1, wherein
the first stop and/or the second stop are arranged upstream of the zoom unit in the direction of the light beam.

3. The optical device as claimed in claim 1, wherein
the zoom unit is designed such that the light beam is optionally modified in the first plane and in the second plane.

4. The optical device as claimed in claim 1, wherein
the optical device is designed such that the extent of the light beam is decreased by the optical device.

5. The optical device as claimed in claim 1, wherein
the distances between the movable lenses and the fixed lens are optionally adjusted over a continuous range.

6. The optical device as claimed in claim 1, wherein
a lens is arranged between the first stop and the second stop.

7. The optical device as claimed in claim 1, wherein
the zoom unit is designed such that the extent of the light beam is modified in two planes that are oriented perpendicularly to each other.

8. The optical device as claimed in claim 1, wherein
the first stop and the second stop are arranged such that an increase in a diameter of the first stop and a decrease in a diameter of the second stop both lead to an increased extent of the light beam.

9. A beam device, comprising:
an optical device as claimed in claim 1, and
a light device for generating the light beam.

10. A light-sheet microscope, comprising:
an optical device as claimed in claim 1.

11. A confocal microscope, comprising:
an optical device as claimed in claim 1.

12. A method for generating a modified light beam, the method comprising:
generating a light beam;
guiding the light beam through a first stop for delimiting the light beam in a first plane;
guiding the light beam through a second stop for delimiting the light beam in a second plane aligned at a predefined non-zero angle to the first plane; and
guiding the light beam through a zoom unit for modifying the extent of the light beam, the zoom unit comprising at least one fixed lens and at least two lenses that are movable relative to the fixed lens along a first axis.

13. The method as claimed in claim 12, further comprising:
adjusting the distance between the movable lenses and the fixed lens over a continuous range in order to modify the light beam.

14. The method as claimed in claim 13, wherein
the light beam is initially guided through the first stop and/or the second stop, before the light beam is guided into the zoom unit.

15. The method as claimed in claim 12, wherein
the extent of the light beam is increased by the zoom unit.
